(19) United States
(12) Patent Application Publication
(10) Pub. No.: US 2020/0130007 A1
(43) Pub. Date: Apr. 30, 2020

(54) STEP CAVITY LOW-FREQUENCY ULTRASONIC ATOMIZING NOZZLE HAVING VORTEX FLOW IMPELLER

(71) Applicant: JIANGSU UNIVERSITY, Jiangsu (CN)

(72) Inventors: Jianmin GAO, Jiangsu (CN); Junlong MA, Jiangsu (CN)

(21) Appl. No.: 16/608,119

(22) PCT Filed: May 23, 2017
(86) PCT No.: PCT/CN2017/085442

§ 371 Date: Oct. 24, 2019

(30) Foreign Application Priority Data
May 4, 2017 (CN) 201710308614.X

(51) Int. Cl. B05B 17/06; B05B 1/34

(52) U.S. Cl. CPC B05B 17/0615; B05B 1/341

(57) ABSTRACT

A step cavity low-frequency ultrasonic atomizing nozzle includes an air inlet casing tube, a water inlet casing tube, a de Laval valve, a fixed cap, a first adjustable base, a tapered rectification sleeve, a vortex flow impeller, a stepped resonance tube, an adjustment plunger, a positioning screw, and a second base. The adjustment plunger is located within a second step hole of the stepped resonance tube, and the axial position thereof is adjustable. The vortex flow impeller is fixed on the stepped resonance tube via a bearing, and an outer tapered surface thereof attaches to an inner tapered surface of the tapered rectification sleeve.

### TECHNICAL FIELD

The invention relates to a two-phase atomizing atomization nozzle, in particular to a step cavity type low-frequency ultrasonic atomization nozzle with a swirlable vortex impeller.

### BACKGROUND TECHNIQUE

At present, in the field of aeroponics, the atomization methods used mainly include piezoelectric ultrasonic atomization and mechanical atomization (such as two-phase atomization of better droplets). Piezoelectric ultrasonic atomization nozzles have the advantages of small and uniform droplets, but its small amount of atomization, only used for small-scale atomization cultivation; the advantages of two-phase atomization nozzle is the large amount of atomization, the disadvantage is that droplet size is large and poor uniformity. Therefore, optimizing the design of the two-phase flow nozzle to fully utilize the energy of the high-speed air flow, it is imperative to develop an atomization nozzle that can generate fine and uniform high-quality droplets and a large amount of atomization.

### SUMMARY OF THE INVENTION

In view of the deficiencies of the lack of existing technology, the invention discloses a step chamber type low frequency ultrasonic atomization nozzle with a swirlable vortex impeller. By optimizing the shape of the two-phase flow nozzle cavity and optimizing the flow path of the two-phase flow nozzles, a large number of uniform ultra-fine mist droplets can be generated under low energy consumption conditions. the invention adopted the specific technical solutions as follows:

A step cavity type low frequency ultrasonic atomization nozzle with a swirling vortex impeller includes an air inlet casing, an inlet casing, a Laval valve core, a fixed cap, an adjustable base, a conical rectifier sleeve, and a vortex flow Impeller, step type resonance tube, adjusting plunger, positioning screw, second base; the inlet sleeve has an inlet hole in the center and a liquid inlet hole in the side wall; the center of the cone-shaped rectifier sleeve The through hole has a cylindrical section and a conical section; a threaded hole is formed at a center of the second base, and a rectangular groove is formed on an end surface of the second base; and the adjustable base is threadably connected to the intake sleeve; Outer ring, and adjustable axial position of the base; The cone-type rectification sleeve, the second base are fixed on the adjustable base through the positioning screw; The water inlet sleeve, The core of Laval valve and the fixed cap are located in the space surrounded by the through hole of the cylindrical section of the air intake sleeve and the conical rectification sleeve; one end of the fixed cap is threadedly connected to the air intake sleeve, and the water inlet sleeve The center has a through hole and is installed in the air intake casing, and a sealing ring is arranged between the air inlet casing and the air inlet casing. The water jacket extends into the fixed cap. Both ends of the Laval valve core are fixedly connected to the end of the water inlet tube and the end surface of the cylindrical segment hole of the fixed cap through the metal glue; the air inlet and the water inlet sleeve of the inlet sleeve are respectively fixedly connected; The through hole of the tube and the Laval valve element constitutes a gas passage, said liquid inlet hole, the gap between the inlet valve sleeve and the inlet valve sleeve, the through hole of the fixed cap, and the Laval valve core. The liquid inlet hole constitutes a liquid passage; the resonant cavity of the ladder-type resonance tube is in a stepped shape, one end is fixedly connected with the second base through an adjustment plunger, and the other end extends to the end face of the fixed cap; the swirlable vortex impeller passes through the bearing The utility model is mounted on a ladder-type resonance tube and is located in a conical section of a through hole of a conical rectification sleeve. The longitudinal section of the swirlable vortex impeller is conical, and the external conical surface of the swirlable impeller and the conical rectification sleeve There is a gap between the tapered surfaces, and a ring-shaped groove is provided on the end surface of the fixed cap. The longitudinal groove of the annular groove has a parabolic shape, and the annular groove and the end face of the swirlable vortex impeller form a second resonance region. The plunger body of the regulating plunger is located The second stepped hole of the trapezoidal resonance tube is internally and in interference fit with the second stepped hole and functions as a seal. The depth of the second-order hole of the stepped resonance tube is adjusted by adjusting the axial position of the plunger; the plunger The body is also connected with a needle exciter which passes through the resonant cavity of the ladder type resonance tube and extends to the Laval valve core outlet section.

Preferably, the ratio of the first-order aperture to the second-order aperture of the second-order cavity of the stepped resonance tube is 1.5-3, and the ratio of the depth of the second-order hole to the first-order hole is adjustable in the range of 1-5.

Preferably, the inner surface of the resonant cavity of the stepped resonance tube is saw-toothed.

Preferably, the inclination angle of the sawtooth longitudinal section of the inner surface of the resonant cavity is 12-25°, and the saw tooth length is 1.5-2.5 mm.

Preferably, the parabolic line profile of the cross-section of the annular groove on the end face of the fixed cap is: x=my²+ny+p, the slope of the end curve of the parabola near the center of the fixed cap is the same as the slope of the conical surface of the cone-shaped rectifying sleeve.

Preferably, the clearance between the rotatable vortex impeller and the inner conical surface of the conical rectifying sleeve is 0.5-1 mm, and the clearance between the wall surface of the center hole of the spiral vortex impeller and the outer surface of the stepped resonance tube is 0.2-0.4 mm.

Preferably, the angle α between the Iconnecting line of the starting point and the ending point of the pressure surface of the swirlable impeller blade is 25°-35°.

Preferably, the blades of the swirlable vortex impeller are unequal thickness blades, the contour curve of the pressure surface of the blade is a cubic polynomial curve y=ax²+bx²+cx+d, and the pressure surface profile curve is determined by the position and slope of the starting point and the ending point; The profile curve of the suction surface of the blade is an arc x²+y²+ex+fy+g=0, and the suction surface profile is determined by the position of the starting point and the ending point and the starting point slope.

Preferably, the exciter diameter is 0.5-0.8 mm, the material of the plunger body is aluminum alloy 1050, the outer surface of the aluminum alloy cylinder is covered with urethane rubber, and the thickness of the rubber layer is 0.3-0.5 mm.

Preferably, the taper hole angle of the tapered rectification sleeve is 60°, the slope of the end curve of the parabola near the center of the fixed cap is \sqrt{3}/3, The cone angle of the outer conical surface of the swirlable vortex impeller is 60°. Cone-type rectification sleeve has an annular groove on the outer cylinder surface at a distance of 5-10 mm from the end surface, and a sealing gasket is installed between the bottom surface of the cone rectification sleeve and the adjustable base.

The liquid is merged with the high-speed air flow at the out of the Laval valve core. The liquid is impacted and broken up to form large droplets. The first atomization occurs. The droplet group continues to enter the stepped resonant cavity with the high-speed jet, and the first regular resonance of a two-phase fluid in a stepped resonator, the fluid in the cavity oscillates at frequency about 5-12 KHz, the large droplets are further shredded and refined, and the second atomization occurs; the fixed-face cap 14 face groove and the cone-shaped rectifier sleeve barrel 7 is combined to form a second resonance zone, The mist enters the second resonance zone after exiting from the stepped resonance cavity. In the second resonance zone, the two-phase fluid oscillates irregularly, so that the fog is sprayed for the third time. The droplet size is further reduced; the droplet finally enters the vane space of the swirlable impeller 8 under the action of the fluid pressure, and under the action of the fluid pressure, the swirlable impeller 8 rotates at a high speed, and the droplet rotates with the impeller at a high speed. The centrifugal motion occurs when flying out of the impeller, and the fourth atomization of the droplet occurs under the effect of centrifugal force, at the same time, the droplet distribution is more uniform.

In the present invention, the shape of the resonant cavity is set to be a ladder type, and the sudden change in the space within the resonant cavity increases the resonant frequency of the fluid in the tube, reaching 1.7 times before the change, the maximum frequency can reach 12.137 kHz, The increase of resonance frequency plays a positive role in the second atomization process of the nozzle. At the same time, the inner surface of the stepped resonant cavity is set to a zigzag shape. When the two-phase flow is refluxed out of the resonant cavity, the mist collides with serrated protrusions multiple times, The local two-phase flow will produce a local disturbance, the zigzag shape intensifies the instability of the two-phase fluid in the cavity, and enhances the fluctuation of the fluid in the cavity, which is favorable for the fluid in the cavity to enter the resonance state more easily.

The annular groove of the end face of the fixed cap and the end face of the cone-type rectifying sleeve constitute a second resonance region, and the high-speed two-phase fluid irregularly reflects and oscillates in the second resonance region, so that the sound pressure level during the working of the nozzle is increased by about 10 dB. The strong sound field area is conducive to further cracking and refining of the fog droplets.

A swirlable impeller is installed at the outlet of the nozzle. On the one hand, the high-speed rotating vortex impeller further refines the centrifugal movement of the droplet. On the other hand, the droplet distribution is more uniform in the space within the injection angle range.

Finally, the exciter penetrates deep into the outlet section of the Laval nozzle. The exciter can effectively reduce the total pressure at the opening of the stepped resonant tube, which is beneficial to the discharge of compressed gas in the resonant cavity and also makes it easier for the two-phase fluid to reach resonance. When the air supply pressure is greater than 0.15 MPa, the resonance frequency of the resonator of the step type resonance tube 11 is adjustable from 5.45 kHz to 12.137 kHz.

### BRIEF DESCRIPTION OF THE DRAWINGS

FIG. 1 is a sectional view of a step chamber type low frequency ultrasonic atomizing spray head with a swirlable vortex impeller according to the present invention;

FIG. 2 shows the adjustable plunger and ladder type resonance tube matching diagram;

FIG. 3 is a cross-sectional view of the fixed cap end and the end face line type comparison chart;

FIG. 4 is a two-dimensional schematic view of a swirlable impeller;

FIG. 5 shows a three-dimensional view of a swirlable impeller.

In the picture:
1—Intake Casing; 2—Inlet Casing; 3—Seal; 4—Inlet; 5—Adjustable Pedestal; 6—Positioning Lead; 7—Taper Rectifying Sleeve; 8—Vortexable Impeller; 9—second pedestal; 10—bearing; 11—stepped resonance tube; 12—regulative plunger; 13—compression nut; 14—fixed cap; 15—Lairal cartridge; 16—inlet Hole; 1201—exciter; 1202—plunger body; 1203—fixed shaft

### DESCRIPTION OF EXEMPLARY EMBODIMENTS

The present invention will be further described below with reference to the accompanying drawings and specific embodiments, but the scope of protection of the present invention is not limited thereto.

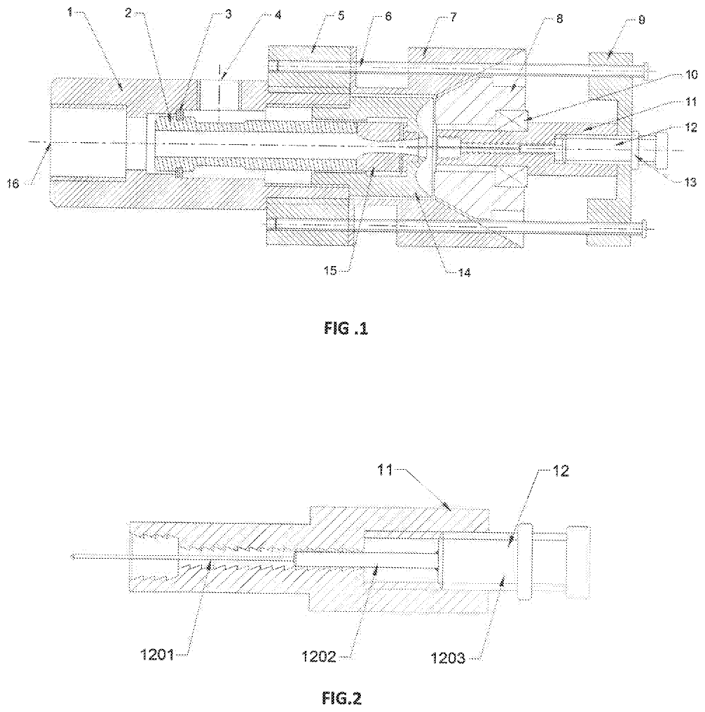

As shown in FIG. 1, the step chamber type low frequency ultrasonic atomizing nozzle with a swirlable vortex impeller according to the present invention mainly comprises an air intake casing 1, a water inlet casing 2, a Laval valve core 15, and a fixed cap 14. The adjustable base 5, the conical rectification sleeve 7, the vortex impeller 8, the stepped resonance tube 11, the adjustment plunger 12, the positioning screw 6, and the second base 9 are formed. The inlet sleeve 1 has an inlet in the center and a liquid inlet hole in the sidewall; the through hole at the center of the cone-shaped rectifier sleeve 7 has a cylindrical section and a conical section; the second base 9 is A screw hole is formed in the central position, and a rectangular groove is formed on one end surface of the second base 9. The adjustable base 5 is screwed on the outer ring of the air intake tube 1, and the axial position of the adjustable base 5 can be Tuning; The cone-type rectification sleeve 7 and the second base 9 are fixed on the adjustable base 5 by the positioning screw 6; the outer surface of the cone-shaped rectification sleeve 7 is opened at a distance of 5-10 mm from the tip surface. The annular groove is provided with a sealing washer between the bottom end surface of the cone-type rectifier sleeve 7 and the adjustable base 5. The water inlet sleeve 2, the Laval valve core 15, and the fixed cap 14 are all located in the space enclosed by the through hole of the cylindrical section of the Intake sleeve 1 and the conical rectification sleeve 7. One end of the fixed cap 14 is threadedly connected to the inlet casing 1. The outer diameter of the inlet casing 2 is slightly smaller than the inner diameter of the inlet casing 1. The center of the inlet casing 2 has a through hole and is installed in the inlet. In the air sleeve 1, a seal ring 3 is provided between the air intake sleeve 1. The water inlet sleeve 2 extends into the fixed cap 14, and both ends of the Laval valve core 15 are fixedly connected with the ends of the water inlet sleeve 2 and the cylindrical segment hole end surface of the fixed cap 14 through the metal glue. The air hole of the air Inlet sleeve 1, the water inlet pipe 2 and the through hole of the Laval valve core 15 constitute a gas passage, and the liquid inlet hole, the water inlet sleeve 2 and the Laval valve core 15 and the air inlet sleeve 1 The gap between the through holes of the fixed cap 14 and the liquid inlet hole of the Laval valve core 15 constitute a liquid passage.

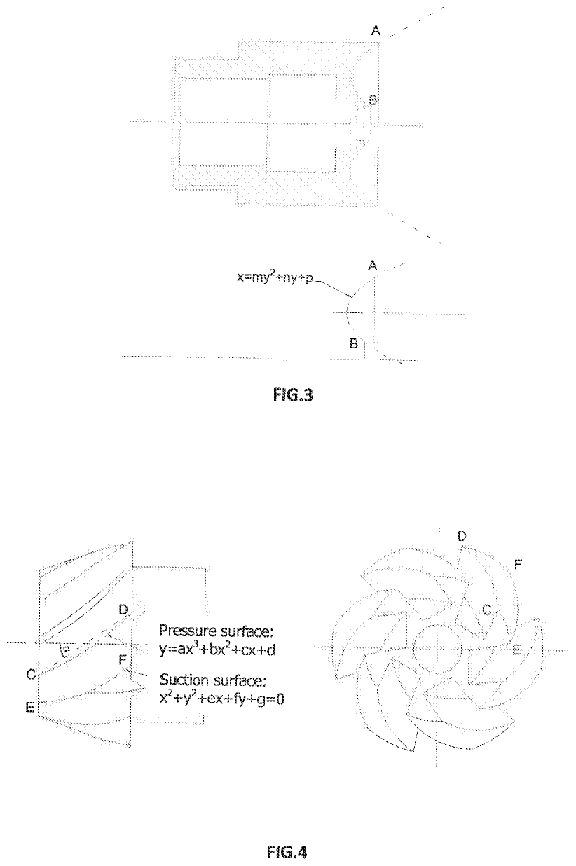

As shown in FIG. 2, the resonance cavity of the stepped resonance tube 11 is a second-order stepped hole, the inner surface of the resonance cavity is saw-tooth type, the inclination angle of the sawtooth longitudinal section is 12-25°, and the saw tooth length is 1.5-2.5 mm. The closed end of the stepped resonance tube 11 has a threaded hole, and the threaded hole cooperates with the fixed shaft 1203 of the regulating plunger 12 to realize the adjustable depth of the second-order hole of the stepped resonant cavity. The regulating plunger 12 is composed of three sections. The first section is the exciter 1201, the second section is the plunger body 1202, the third section is the fixed shaft 1203, the fixed shaft 1203 is threaded on the cylindrical surface, and the material of the plunger body 1202 is For the aluminum alloy 1050, the outer surface of the aluminum alloy cylinder is covered with polyurethane rubber, and the thickness of the rubber layer is 0.3-0.5 mm. One end of the stepped resonance tube 11 is fixedly connected to the second base 9 through the adjustment plunger 12. The plunger body 1202 of the adjustment plunger 12 is located in the second stepped hole, the interior of the stepped resonance tube 11, and the first The second stepped hole has an interference fit that acts as a seal to ensure that the seal does not leak. The depth of the second-order hole in the stepped resonance tube 11 is adjusted by adjusting the axial position of the plunger 12. The sawtooth shape of the inner surface of the stepped resonator cavity exacerbates the instability of the two-phase fluid in the cavity, which will enhance the fluctuation of the fluid in the cavity, making it easier for the two-phase fluid to form a resonance. In addition, when the compressed fluid flows out of the resonant cavity, the droplets collide with the serrated surface of the cavity wall several times when flowing out with the gas, which is beneficial to the further refinement of the mist droplets. The ratio of the first-order aperture to the second-order aperture of the second-order cavity of the stepped resonance tube 11 is 1.5-3, and the ratio of the depth of the second-order hole to the first-order hole is adjustable in the range of 1-5.

The other end of the stepped resonance tube 11 extends to the end surface of the fixed cap 14; the vortex impeller 8 is mounted on the stepped resonance tube 11 through a bearing and is located in a conical section of the through hole of the cone rectification sleeve 7. The outer surface of the stepped resonance tube 11 is a stepped shaft to achieve the installation and positioning of the bearing 10. The longitudinal section of the swirlable vortex impeller 8 is tapered, and there is a gap between the outer cone surface of the spiral vortex impeller 8 and the inner cone surface of the cone-type rectification sleeve 7. The gap between the spiral vortex impeller 8 and the inner cone surface of the cone-type rectifier sleeve 7 is 0.5-1 mm, and the gap between the center hole wall surface of the spiral vortex impeller 8 and the outer surface of the stepped resonance tube 11 is 0.2-0.4 mm. A ring-shaped groove is provided on the end face of the fixed cap 14, and the longitudinal groove shape of the ring groove is parabolic. The ring-shaped groove and the end surface of the swirlable vortex impeller 8 form a second resonance region. The exciter 1201 passes through the resonant cavity of the stepped resonance tube 11 and extends to the outlet section of the Laval valve core 15. The exciter 1201 effectively reduces the total pressure at the opening of the stepped resonance tube 11 and facilitates the discharge of compressed gas in the cavity. It also makes the two-phase fluid easier to reach resonance. When the air supply pressure is greater than 0.15 MPa, the resonance frequency of the resonator of the step type resonance tube 11 is adjustable from 5.45 kHz to 12.137 kHz.

As shown in FIG. 3, the parabolic line shape of the section of the annular groove on the end surface of the fixed cap 14 is determined by the coordinates of point A, its slope, and the coordinates of point B. The slope of the end curve of the parabola near the center of the fixed cap 14 is the same as that of the conical surface of the cone-shaped rectifying sleeve 7, and the annular groove is smoothly connected with the cone-shaped rectifying sleeve 7. The tapered cone angle of the cone-type rectifying sleeve 7 is 60°, the slope of the end curve of the parabola near the center of the fixed cap 14 is a slope of the outer-conical surface of the swirlable vortex impeller 8 is 60°.

As shown in FIGS. 1 and 3, the parabolic groove in the longitudinal section causes the two-phase fluid to be smoothly led to the second resonance region after flowing out of the stepped resonance tube 11. In this region, the high-speed two-phase fluid is in the second resonance region. The irregularly reflected oscillations increase the sound pressure level of the sprinkler during operation by approximately 10 dB to approximately 95 dB.

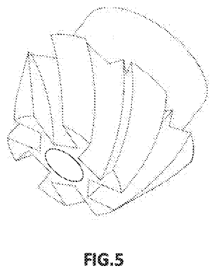

As shown in FIG. 4 and FIG. 5, the longitudinal section of the swirlable vortex impeller 8 is conical, the cone angle is 60°, and the angle α between the starting point and the ending point of the pressure surface of the blade is 25°-35°. The blades of the swirlable vortex impeller 8 are unequal thickness blades. The contour curve of the pressure surface of the blade is a cubic polynomial curve. The contour curve of the blade suction surface is a circular arc, and the pressure surface profile curve is from the starting point C and the ending point. The position coordinates and slope of D are determined. The suction surface type is determined by the position coordinates of the starting point E and the ending point F and the slope of the starting point. The slope of the starting point is set to 0.3 to 0.7, and the slope of the ending point is set to 0.5 to 1. The supply pressure adjustment range is 0.15-0.5 MPa, and the rotation range of the swirlable impeller 8 is 400-1000 r/min.

At the time of installation, the water inlet tube 2, the Laval valve core 15 and the fixed cap 14 are first fixed together with metal glue, and then the fixed cap 14 is screwed into the inner threaded hole at the end of the inlet tube 1; The vortex impeller 8 is fixedly connected to the shoulder of the stepped shaft of the stepped resonance tube 11 through the bearing 10, and the second base 9 and the stepped resonance tube 11 are fixedly connected by adjusting the fixing shaft 1203 of the plunger 12; The positioning screw 6 is screwed into the corresponding screw hole of the second base 9, the tapered rectifying sleeve 7 and the adjustable base 5 in order as shown in FIG. 1, and the relative positions thereof are adjusted.

Work process: High-pressure gas 0.15-0.5 MPa is connected by the air intake hole 16 at the end of the nozzle, and the liquid is merged with the high-speed air flow at the exit of the Laval tube. The liquid is impacted and broken up to form a large droplet, the first atomization occurs, and then the fog The droplets continue to enter the stepped resonant cavity with high-speed jets. The first phase of the two-phase fluid resonates regularly in the stepped resonant cavity. The fluid in the cavity oscillates at a frequency of about 5-12 KHz, and the large droplets are further cracked and refined. A second atomization occurs. In this process, the sawtooth type changes on the inner surface of the exciter 1201 and the step type resonance tube 11 all contribute to the stable resonance of the step type resonant cavity; the mist enters from the step type resonant cavity and enters The second resonance region and the second resonance region are internal space regions formed by the combined combination of the end face groove of the fixed cap 14 and the cone-shaped rectifying sleeve 7. In the second resonance region, the two-phase fluid oscillates irregularly, and the sound pressure level of the strong sound field is about The 95 dB region is favorable for further fogging and refining of the fog droplets, so that the third atomization of the fog droplets occurs, and the particle size of the droplets further decreases; finally, the droplets enter the blade gap of the swirlable vortex impeller 8 under the action of the fluid pressure. In the meantime, under the action of the fluid pressure, the rotary vortex impeller 8 rotates at a high speed of 400-1000 r/min, the supply pressure adjustment range is 0.15-0.5 Mpa, the droplets rotate with the impeller at high speed, and centrifugal occurs when flying out of the impeller. In the movement, the fourth atomization of the droplet occurs under the effect of centrifugal force, and at the same time, the distribution of the droplets is more uniform. At the same time, the high-speed rotation of the swirlable eddy impeller 8 makes the droplet cluster more evenly distributed in the space area within the injection angle range.

The embodiment is a preferred embodiment of the present invention, but the present invention is not limited to the above embodiment, and any obvious improvement, substitution, or substitution can be made by those skilled in the art without departing from the spirit of the present invention. Variations all fall within the protection scope of the present invention.

1: A stepped cavity type low-frequency ultrasonic atomizing nozzle with a swirling vortex impeller, said atomizing nozzle comprising: an air inlet casing, a water inlet casing, a Laval valve core, a fixed cap, an adjustable first base, a cone rectification sleeve, a whirlpool impeller, a stepped resonance tube, an adjustment plunger, a positioning screw, and a second base;
wherein the water inlet casing comprises an inlet sleeve having an inlet in a center thereof and a liquid inlet hole in a sidewall thereof;
wherein the through hole in the center of the inlet sleeve has a cylindrical section and a cone, a threaded hole is formed in a central position of the second base, a rectangular groove is formed on one end surface of the second base, and the adjustable base is fixed to the air inlet casing;
wherein an outer ring of the bushing, and an axial position of the adjustable base is adjustable; wherein the cone rectification sleeve includes a conical rectification bushing, and the second base is fixed by a positioning screw on the adjustable base;
wherein the water inlet sleeve, the Laval valve core and the fixed cap are all located on the inlet sleeve and a cylindrical section of the conical rectification sleeve in a space enclosed by the through hole;
wherein one end of the fixed cap is threadedly connected to the air inlet casing, and the center of the inlet casing has a through hole and is installed in the air inlet casing;
wherein in the sleeve, a sealing ring is arranged between the sleeve and the inlet sleeve, and the inlet sleeve extends into the fixing cap;
wherein the Laval valve core has two ends which are respectively fixedly connected with the end of the water inlet sleeve and the end face of the cylindrical segment of the fixed cap through a metal glue;
wherein the air inlet casing and the water inlet sleeve of the air inlet sleeve and the through holes of the Laval valve core constitute gas passages, wherein the inlet hole, the water inlet sleeve and the Laval valve core and the inlet sleeve, the fixed cap, the gap between the through holes and the inlet hole of the Laval valve core constitute a liquid passage;
wherein the resonator of the resonance tube is in the form of a step, and the plunger and the end are adjusted by one end;
wherein the first base and the second base are fixedly connected at one end, and the other end extends to an end face of the fixed cap; wherein the vortex impeller is mounted on the resonance tube through the bearing, and located in the conical section of the through hole of the conical rectification sleeve, the longitudinal section of the swirlable vortex impeller is conical, and the outer conical surface of the vortex impeller is conical;
wherein there is a gap between the inner cone surfaces of the cone-type rectifying sleeve, and an annular groove is provided on the end surface of the fixed cap;
wherein the longitudinal groove shape of the annular groove is a parabolic shape;
wherein the end surface of the spiral vortex impeller forms a second resonance region;
wherein the plunger body of the regulation plunger is located in the second stepped hole of the resonance tube wherein the interference of the two stepped holes plays a role of sealing; and
wherein a depth of the second-order hole of the stepped resonance tube is adjustable by adjusting the axial position of the plunger.

2: The stepped cavity type low-frequency ultrasonic atomizing nozzle of claim 1, wherein a ratio of a first-order aperture and a second-order aperture of the second-order cavity of the stepped resonance tube is 1.5-3, and a ratio of the depth of the second-order hole to the first-order hole is adjustable from 1-5.

3: The stepped chamber type low-frequency ultrasonic atomizing nozzle of claim 1, wherein the inner surface of the resonant cavity of the stepped resonant tube is saw-toothed, the inclined angle of the sawtooth longitudinal section is 12-25°, and the saw tooth length is 1.5-2.5 mm.

4: The stepped cavity type low-frequency ultrasonic atomizing atomizing nozzle of claim 1, further comprising a pin-shaped exciter connected to the plunger body, wherein the exciter passes through the resonant cavity of the stepped resonance tube and extends to the outlet section of the Laval valve core.

5: The step chamber type low-frequency ultrasonic atomizing atomizing nozzle of claim 1, wherein the annular groove section on the end face of the fixed cap has a parabolic line shape defined by the formula: x=my²+ny+p; and
wherein the slope of the endpoint curve of the center is the same as the slope of the conical surface of the cone-type rectifying sleeve.

6: The stepped cavity type low-frequency ultrasonic atomizing nozzle of claim 1, wherein the conical swirling impeller and the cone-shaped rectifying sleeve are internally tapered; the gap between them is 0.5-1 mm; and, the gap between the wall of the center hole of the vortex impeller and the outer surface of the stepped resonance tube is 0.2-0.4 mm.

7: The step chamber type low-frequency ultrasonic atomizing atomizing nozzle of claim 1, wherein the starting point and the ending point of the pressure surface of the blade of the swirlable vortex impeller are connected at an angle α of 25°-35° to the axis.

8: The step chamber type low-frequency ultrasonic atomizing nozzle with a swirlable vortex impeller of claim 1, wherein the blades of the swirlable vortex impeller are unequal thickness blades defined by the formula: y=ax³+bx²+cx+d; the pressure surface of the blade is defined by a cubic polynomial curve; the pressure surface profile curve of the blade is determined by the position and slope of the starting point and ending point; the contour curve of the blade suction surface is a circular arc defined by the formula: x²+y²+ex+fy+g=0; and the suction surface profile is determined by the starting and ending points and the starting point slope.

9: The step chamber type low-frequency ultrasonic atomizing nozzle of claim 1, wherein the exciter has a diameter of 0.5-0.8 mm; the plunger body is formed of an aluminum alloy; the outer surface of the cylinder of the plunger is covered with a polyurethane rubber layer having a thickness of 0.3-0.5 mm.

10: The step chamber type low-frequency ultrasonic atomization nozzle of claim 1, wherein the fixed cap has a parabolic curve near the center of the fixed cap of 60°; the cone angle of the outer conical surface of the swirlable impeller is 60°; the slope of the parabolic curve near the center of the fixed cap is defined by \sqrt{3}/3, the outer surface of the cone of the cone-type rectification sleeve is spaced from the end surface; a ring groove has an opening of 5-10 mm, and a sealing gasket is installed between the bottom end surface of the cone-type rectification sleeve and the adjustable base.

11: The step chamber type low-frequency ultrasonic atomizing atomizing nozzle of claim 4, wherein the starting point and the ending point of the pressure surface of the blade of the swirlable vortex impeller are connected at an angle α of 25° to 35° to the axis.

12: The step chamber type low-frequency ultrasonic atomization nozzle of claim 3, wherein the fixed cap has a parabolic curve near the center of the fixed cap of 60°; the cone angle of the outer conical surface of the swirlable impeller is 60°; the slope of the parabolic curve near the center of the fixed cap is defined by \sqrt{3}/3, the outer surface of the cone of the cone-type rectification sleeve is spaced from the end surface; a ring groove has an opening of 5-10 mm, and a sealing gasket is installed between the bottom end surface of the cone-type rectification sleeve and the adjustable base.

13: The step chamber type low-frequency ultrasonic atomization nozzle of claim 4, wherein the fixed cap has a parabolic curve near the center of the fixed cap of 60°; the cone angle of the outer conical surface of the swirlable impeller is 60°; the slope of the parabolic curve near the center of the fixed cap is defined by \sqrt{3}/3, the outer surface of the cone of the cone-type rectification sleeve is spaced from the end surface; a ring groove has an opening of 5-10 mm, and a sealing gasket is installed between the bottom end surface of the cone-type rectification sleeve and the adjustable base.
